(19) United States
(12) Patent Application Publication
(10) Pub. No.: US 2010/0031249 A1
(43) Pub. Date: Feb. 4, 2010

(54) METHOD FOR POLICY BASED ENFORCEMENT OF BUSINESS REQUIREMENTS FOR SOFTWARE INSTALL

(75) Inventors: Prashant B. Baliga, Bangalore (IN); Rohit Shetty, Bangalore (IN)

Correspondence Address: CARPENTER & ASSOCIATES, 5 PIPESTEM COURT, ROCKVILLE, MD, 20854, US

(73) Assignee: International Business Machines Corporation, Armonk, NY (US)

(21) Appl. No.: 12/185,791

(22) Filed: Aug. 4, 2008

(51) Int. Cl. G06F 9/445

(52) U.S. Cl. 717/174

(57) ABSTRACT

A method for policy-based enforcement of business requirements for a software install. The method includes identifying installation prerequisites and business prerequisites based on business policies of a software solution, where the software solution may be installed on a computing machine; identifying software prerequisites required for the software solution; determining whether the business prerequisites and installation prerequisites can be complied without compromising the software prerequisites; on determining that the business prerequisites can he complied, installing the software solution on the computing machine; and on negative determining notifying a user regarding non-compliance of the business prerequisites.

### BACKGROUND OF THE INVENTION

1. Field of the Invention

This invention generally relates to computer systems, and more specifically, to methods for enforcing rules, preferably business related rules, during a software install.

2. Background Art

When a new software program is acquired, it usually must be installed on the target data processing system before it can be used. Typically, software programs include as a component thereof an installer, which is software that substantially automates the installation process. In addition, computer operating systems (software which coordinates resource use by, and interaction between, other software) may include an installer for use in installing drivers or other software.

In addition, many commercial software programs are provided with a process by which they may be updated. Such a process can be included as a component of the software program itself, or may be provided externally. The provision of an updating process is desirable because end users, for example, frequently modify software programs by applying bug fixes or enhancements (such as new versions of the software).

There are many different processes for installing and/or updating software programs. Some processes are entirely automated and substantially invisible to the user, while others are interactive. Some are complex while others are simpler. Software programs used to install new software, to install updates to software, and to uninstall (remove) software are referred to herein as “installer applications.” The term “installer applications” is intended to encompass both “standalone” software programs that can be used to install a variety of software applications (for example, such as installers that may be provided with an operating system), as well as software programs that are adapted to install only a single software application (and may he integrated with the installation file package for that software application). Installer applications, when run, implement a software installation process.

Using any software starts with the installation of the software and its prerequisites. Every software vendor provides his own installation mechanism for his software. Though quite a few applications ensure that they allow customers to govern their usage based on business policies, these applications do not ensure that the software installation itself does not break a customer's business policy. Every software vendor ensures that his software's installer installs the required prerequisites and performs the required preliminary checks, but there is no attempt made to verify that the installation of the software does not break the customer's business policy.

### SUMMARY OF THE INVENTION

An object of this invention is to provide a method for policy based enforcement of a customer's business requirements for software install validate beforehand whether a particular software installation would comply with a customer's business policy, and ensure that a software installation does not break a customer's business policy. Without a method of being able to validate beforehand whether a particular software installation would comply with business policy would add a huge competitive edge to the software vendor as well as help the customer. This feature will help the customer maintain an audit-ready posture with minimal investment of time and human resources.

These and other objectives are attained with a method for policy-based enforcement of business requirements for a software install. The method includes identifying installation prerequisites and business prerequisites based on business policies of a software solution, where the software solution may be installed on a computing machine; identifying software prerequisites required for the software solution; determining whether the business prerequisites and installation prerequisites can be complied without compromising the software prerequisites; on determining that the business prerequisites can be complied, installing the software solution on the computing machine; and on negative determining notifying a user regarding non-compliance of the business prerequisites

Without this infrastructure, the customer has no control over the solution that he has purchased. The customer has no way of verifying that the software solution complies with all his Business Policies. The customer would have to manually carry out an impact analysis, which is a complicated and time-consuming task. Most customers currently overlook these Business Policy violations, as there is no way of enforcing them automatically. This results in audit vulnerability. The solution provided by the present invention, hence, provides an important assurance to customers who are currently facing such problems.

This technique also makes the software install highly flexible, by allowing customers to modify deployment descriptors to suit their business needs as long as it does not conflict with the software prerequisites. This invention will give the vendor a competitive edge over other vendors who are not able to provide flexible solutions that accommodate the customer's Business Policies.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 shows an existing software installation architecture.

FIG. 2 illustrates a software installation architecture embodying this invention, when the Installer is coupled with a Policy Infrastructure.

### DETAILED DESCRIPTION OF THE PREFERRED EMBODIMENTS

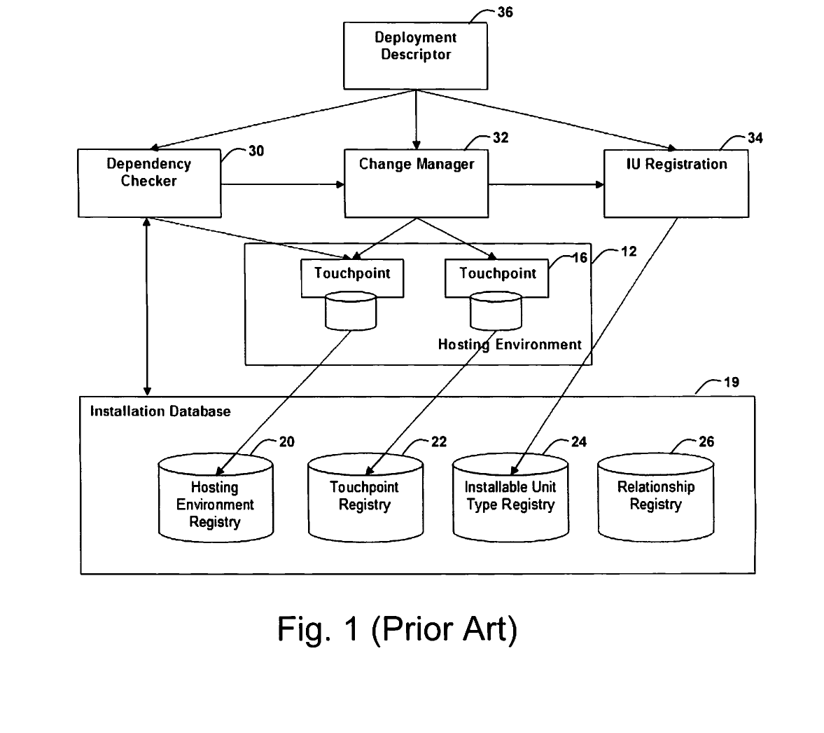

FIG. 1 shows the existing architecture of the above-mentioned Solution Install. This architecture, generally, includes hosting environment 12 and installation database 19. In turn, the hosting environment includes touchpoints 16; and the installation database includes a hosting environment registry 20, a touchpoint registry 22, an installable unit type registry 24, and a relationship registry 26. The architecture of FIG. 1 also includes a Dependency Checker 30, Change Manager 32, IU Registration 34 and Deployment Descriptor 36. The Solution Install architecture is discussed in more detail in the article “Simplify Deployment Tasks with Solution Install Technology,” Charlie Halloran, Jr., May 10, 2005, http://www.ibm.com/developerworks/autonomic/library/ac-sivalue/. Most installers follow the same architecture as the Solution Install, i.e., where a Deployment Descriptor (change plan) and similar interactions as the Solution Install is provided as in the architecture as a solution.

In accordance with the present invention, a Policy Infrastructure is used to manage and run the software installation. As discussed in detail below, the invention enables the customer to enforce Business Requirements (BR) by writing policies that will change the course of installation based on the information gathered from the Deployment Descriptor. The usage of Policies provides an instrumentation to define Business Policies and to automate their enforcement in the installation process.

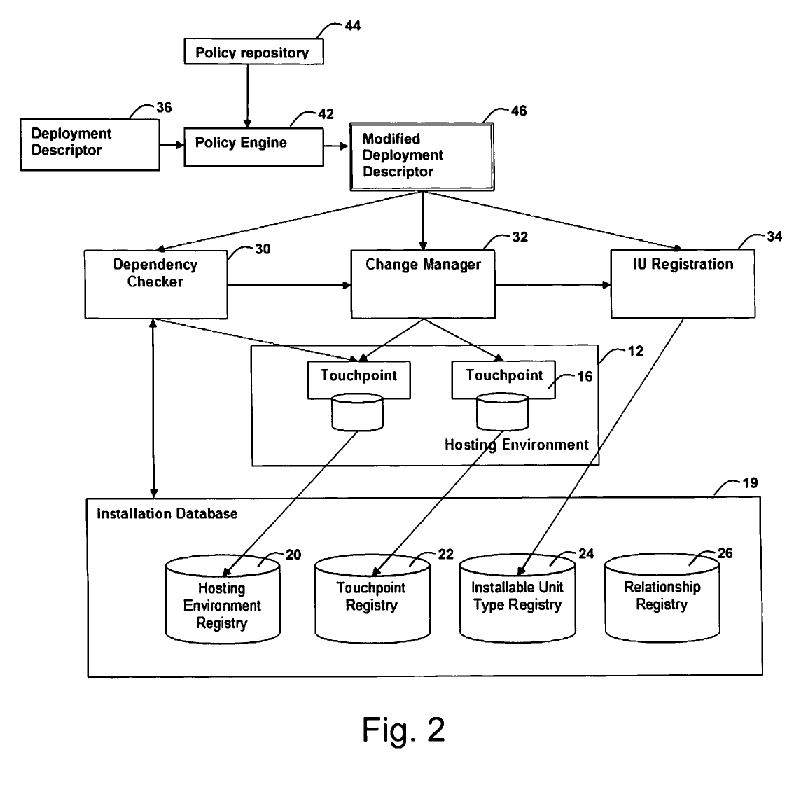

FIG. 2 illustrates an architecture embodying the present invention. This architecture includes the hosting environment, the installation database, the Dependency Checker, the Change Manager, and the IU Registration shown in FIG. 1. In addition, the architecture of FIG. 2 includes a Policy Engine 42 and a Policy Repository 44. The Deployment Descriptor 36 is given as input to the Policy Engine 42 which in turn modifies it according to the policies stored in the Policy Repository 44 and generates the modified Deployment Descriptor 46 which is fed as the new input to the solution installer.

The solution provided by this invention aims to embed a Policy Engine that will interpret the customer's Business Policies for the installer. The Policy is written by the customer to suit his Business Requirements. This Policy is preferably based on the deployment descriptor schema used. This enables the Policy to enforce the business requirements over a range of solutions without being tied to a particular solution.

The architecture aims primarily at creating the best install plan for the given environment. The install plan includes a good mix of Dependencies and the Business Guidelines.

The policy engine includes an actuator that can execute two kinds of actions: Deployment Descriptor Independent Actions; and Deployment Descriptor Dependent Actions. In the case of Deployment Descriptor Independent actions, the action could be any action such as invoking a batch script or system level action. The actuator performs the action specified by the user in the Decision part of the policy. In the case of Deployment Descriptor Dependent actions, the actuator carries out actions on the Deployment Descriptor and modifies it to ensure that it complies with business policies. The Policy engine checks to see if the Deployment Descriptor violates a mandatory clause or condition that is specified in the condition section of the policy and then takes corrective action that is described in the action section of the policy. If the action violates mandatory requirements of the Deployment descriptor then the user is informed of the conflict/violation.

If there is such a violation, then exception approval is sought to ignore the action and to continue the install with possible policy violations. If the action does not violate any mandatory clause of the Deployment Descriptor, then the algorithm goes on and performs the action, i.e., changes the deployment descriptor as required by the policy (for example, if the policy says min 50 MB should exist on the system at all times, the Deployment Descriptor would be used to check for [required+50 MB] dependency).

The following examples illustrate the operation of the invention.

### EXAMPLE 1

A Business Policy of a company, for example “Policy1,” requires that 50 MB of free disk space must be maintained at all times on any given system. Without the Policy Infrastructure of this invention, there would be no way for the company to automatically enforce their policy. They would have to either manually ensure that all systems comply with this policy or buy another solution that takes care of their requirements. This scenario can be handled in an easier manner by using the above-described method.

A solution, for example “Software X,” has a prerequisite of 150 MB of disk space and min 100 MHz processor. This can be represented as follows:
Prerequisite 1 (P1): 150 MB of disk space
Prerequisite 2 (P2): Min 100 MHz processor

The Deployment Descriptor would have a dependency check as follows;

If ((P1) && (P2))
{Return TRUE to Change Manager indicating that all dependencies
have been satisfied}
Else
{Report an Error}

The prerequisite check looks like this:

If ((Available disk space >= (P1+50MB)) && (P2))
{Return TRUE to Change Manager indicating that all dependencies have
been satisfied}
Else
{Report an Error}

The installer (with embedded Policy infrastructure) would install the solution as follows.
1) The installation is triggered.
2) Deployment Descriptor is picked up by the installer.
3) Deployment Descriptor is handed over to Policy Engine.
4) Policy Engine picks up relevant Policies (filtered by scope if required) from the Customers Business Policy Repository.
5) Policy1 is retrieved from the repository and evaluated against the Deployment descriptor.

The data from the Deployment Descriptor (Prerequisites P1 and P2) is given as input to the evaluation engine. The Policy can he interpreted to mean that all software must ensure that they check for 50 MB of disk space beyond their individual requirements. The Condition part of the Policy in this case would check to see if the installation has a disk space prerequisite. Since the current Deployment Descriptor does have a memory prerequisite, the Actuator would be triggered to take the associated action.

The actuator can execute two kinds of actions, either Deployment Descriptor Independent, or Deployment Descriptor Dependent actions. Deployment Descriptor Independent actions could include triggering a shell script that triggers a program. The program could get 50 MB of space allocated to itself and release it after the installation. This is one way of enforcing the Policy. Deployment Descriptor Dependent actions would include modification of the prerequisite to comply with the policy. A check is first made to see if the action violates a mandatory clause of the Deployment Descriptor. Since the memory prerequisite is not being decreased to below the mandatory level of 150 MB, no exception approval messages are thrown. Hence, the deployment descriptor can be changed as required by the policy, i.e., prerequisite P1 is modified to check for 150 MB+50 MB of disk space. The user can be notified about the actions to be taken. This would help him carry out an impact analysis of the installation. The same evaluation process is carried out for all the Policies that have been retrieved from the repository.

After the evaluation process is completed, the business compliant deployment descriptor is provided to the installer. The installer can go ahead and install the Business Policy Compliant Solution, which would ensure 50 MB of free disk space on the system.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A method for installing a software solution, the method comprising:
identifying installation prerequisites and business prerequisites based on a customer's business policies of a software installation, wherein the software solution may be installed on a computing machine and the customer is a purchaser of the software solution;
identifying software prerequisites required for the software solution;
determining whether the business prerequisites and installation prerequisites can be complied without compromising the software prerequisites;
on determining that the business prerequisites can be complied,
installing the software solution on the computing machine; and
on negative determination,
notifying a user regarding non-compliance of the business prerequisites.
